(19) United States
(12) Patent Application Publication
(10) Pub. No.: US 2017/0248190 A1
(43) Pub. Date: Aug. 31, 2017

(54) Machining Unit for a Machine Tool and Machine Tool Having Such a Machining Unit

(71) Applicant: DECKEL MAHO Pfronten GmbH, Pfronten (DE)

(72) Inventor: Frank Gänssle-Klenk, Nesselwang (DE)

(21) Appl. No.: 15/442,477

(22) Filed: Feb. 24, 2017

(30) Foreign Application Priority Data
Feb. 26, 2016 (DE) 102016203116.3

(51) Int. Cl. F16F 15/02; B23Q 11/00; B23Q 1/00; B23Q 1/70

(52) U.S. Cl. CPC F16F 15/02; B23Q 1/70; B23Q 11/0032; B23Q 1/0036

(57) ABSTRACT

A machining unit for a machine tool includes a carrier head base, which on its rear side includes a carriage. The carriage can be coupled to axis guides and is longitudinally displaceable. The machining unit further includes a spindle carrier head held pivotably on the carrier head base. The spindle carrier head has a spindle with a tool holder. The carrier head base is provided with a damping unit. The disclosed machining unit provides increased precision of a machine tool. The machining unit may be incorporated in a machine tool.

### BACKGROUND

In the prior art, machine tools or numerically controlled machine tools, on which workpieces can be machined, in particular by cutting by means of tools, are known. For example, milling machines, milling/turning machines, universal milling machines, or machining centres, in particular with tool-carrying work spindles, are known.

If necessary, machine tools of this type comprise fixed or movable machining units, which carry a work spindle and may, for example, be referred to as spindle carriage, spindle head, or spindle stock. A generic machining unit is described, for example, in EP 1 415 758 A1, along with the drive mechanism of the spindle.

During the chip-removing machining of workpieces by machine tools of this kind, the requirements of a high machining precision at a high surface quality of the machined workpiece and a high productivity at a high operating performance of the machine tool usually arise.

Herein, the operating performance of the machine tool can be achieved, on the one hand, by reducing shutdown periods, and, on the other hand, by increased machining efficiency during machining, e.g., by the highest possible material removal rate during machining of the workpiece, which can be achieved by a faster feed during machining and/or by a deeper plunging of the cutting tool into the workpiece. However, since larger oscillations of the tool occur for a higher material removal rate during machining, a desired increase in productivity by increasing the material removal rate, as a rule, subtracts from the machining precision and the achievable surface quality.

In light of the above problems, it is an object of the present invention to provide an improved chip-removing machining of a workpiece on a machine tool, with which both the highest possible machining precision at a high achievable surface quality and the highest possible productivity at a high material removal rate can be achieved.

### SUMMARY

A representative embodiment of a machining unit for a machine tool is disclosed. The machining unit includes a carrier head base and a spindle carrier head holding a tool-carrying work spindle. The machining unit is provided with a damping unit for damping oscillations occurring during the machining of a workpiece on said machine tool, which improves the speed and accuracy of the machining unit.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows an exemplary perspective view of a machine tool known from the prior art,

FIG. 2 shows an exemplary schematic diagram of the inner workings of the machining unit of the machine tool shown in FIG. 1,

FIG. 3A is an exemplary schematic side view of a machining unit for a machine tool with a damping unit provided thereon according to an exemplary embodiment of the invention,

FIG. 3B shows an exemplary schematic side view of the machining unit from FIG. 3A with the damping unit provided thereon in a different pivoting position of a spindle carrier head of the machining unit, and

FIG. 4 shows an exemplary view of a damping unit according to an exemplary embodiment.

### DETAILED DESCRIPTION

In the following, examples or exemplary embodiments of the present invention are described in detail with reference to the accompanying figures. Identical or similar elements in the figures may be designated with the same reference signs, but sometimes also with different reference signs.

It should be noted, however, that the present invention is in no way limited or restricted to the exemplary embodiments described below and their features, but rather also includes modifications of the exemplary embodiments, in particular those which fall within the scope of the independent claims via modifications of the features of the described examples or via the combination of one or more of the features of the described examples.

The present invention relates to a machining unit for a machine tool, in particular a numerically controlled machine tool or, in particular a numerically controlled machine tool having a spindle device with a tool-carrying work spindle. In order to achieve the above object, according to the present invention, a machining unit for use on a machine tool according to claim 1 is proposed. Dependent claims relate to preferred exemplary embodiments.

The invention is based on the inventive concept of dampening oscillations occurring during the machining of the workpiece, so that, at a higher material removal rate, due to a oscillation damping unit on the machining unit of the machine tool carrying the working spindle and the associated oscillation damping during machining of the workpiece at higher feed rates and/or deeper plunging of the tool into the workpiece in order to increase the productivity and operating performance of the machine tool, a significantly increased machining precision and an improved surface quality can nevertheless be achieved.

According to the invention, a machining unit for a machine tool is proposed, which has a carrier head base and a spindle carrier head holding a tool-carrying work spindle, wherein the machining unit is provided with a damping unit for damping oscillations occurring during the machining of a workpiece on the machine tool.

The machining unit, or in particular the spindle carrier head, or preferably the carrier head base of the machining unit may be provided with a damping unit for this purpose. Remarkably, it has been found that, although the entire carrier head base is slidably or displaceably mounted, it is possible to provide a damping unit at this carrier head base.

If this damping unit is provided as close as possible to the spindle carrier head, the machining precision of the workpiece can be greatly improved.

According to an advantageous further development, the damping unit may be arranged on an outer side of a housing of the carrier head base.

If the damping unit is arranged on an outer side of the housing, no space is occupied in the interior space of the housing of the carrier head base, which space can be used, for example, for the gear box and/or a motor or drive.

Furthermore, the damping unit is therefore easy to reach, for example, for maintenance or for attachment or removal thereof. In particular, it may be advantageous to provide the damping unit on the outer side of the housing in such a way that it is mounted in an easily accessible location.

According to an advantageous further development, the damping unit may be provided as a separate element, which may be installed as such or may be incorporated and removed.

The damping unit may then be attached to the carrier head base as an independent ensemble and may thus be easily mounted thereon, for example, by means of screws or other fastening means and may also be dismounted therefrom. By means of this embodiment, the damping unit may be adapted or replaced based on the damping necessary for the workpiece to be machined.

According to a preferred further development, the spindle carrier head may be supported so as to be pivotable about an axis extending obliquely relative to the direction of displacement of the carriage, so that the tool holder may be pivoted from one position to a second position during pivoting.

In particular in such a configuration with a pivot axis extending obliquely, the damping unit may be provided in such a way that the damping unit and the spindle carrier head do not or do not substantially interfere with each other when pivoting.

In this case, the damping unit may, for example, be provided on a surface of the carrier head base (the housing of the carrier head base), which is oriented in parallel to the pivot axis and is therefore likewise extending obliquely, and thus prevent a collision of the spindle carrier head and the damping unit during pivoting.

According to a preferred further development, the damping unit may ensure a uniaxial damping, and is, in particular, configured to dampen oscillations in a main damping effect direction.

If the carrier head base with its carriage is displaceable in the Z direction, preferably, damping in the direction of the Z axis may be ensured. If the carrier head base with its carriage is mounted displaceably in the X or Z direction, preferably, damping in these directions may be ensured.

However, since oscillations can generally occur in all directions, it is preferred that one or more damping units are configured such that oscillations can be damped in all directions or at least main components of the oscillation directions can be damped.

For this purpose, preferably a plurality of damping units with respective uniaxial damping may be provided whose main damping effect directions (may also be referred to as main damping action directions) are oriented in different directions of the machining unit.

According to a preferred further development, the damping unit may have at least one of the following types of damping: a viscoelastic damping element, a piezoelectric damping element, an electrodynamic damping element and a squeeze film damping element.

In general, the damping unit may be based on a wide variety of damping types known in the art. However, it has been found that the above-described types of damping elements, namely viscoelastic damping element, piezoelectric damping element, electrodynamic damping element and squeeze film damping element, or a combination thereof, ensure the best damping properties along with small installation sizes.

For example, in a viscoelastic damping element, a mass element such as a metal piece is mounted on or attached to a highly viscous or viscoelastic material.

Accordingly, in the case of a piezoelectric damping element, a piezoelectric material is provided. For example, in the case of vibration, the piezoelectric material is subjected to a voltage by means of a control so that it expands or shortens in order to counteract the oscillation and thus to ensure damping. Such piezoelectric damping elements are known, for example, from DE 699 24923 T2.

By selecting a suitable piezoelectric material and suitable stresses, such a piezoelectric damping element, as described in DE 699 24923 T2 for skis, can be adjusted to the vibration frequencies which usually occur in machine tools.

In an electrodynamic damping element, one or more controllable linear actuators may be provided in order to counteract the occurring oscillation by controlling the linear actuator(s) to counter the oscillation.

In a squeeze film damping element, a liquid is pressed or drawn from a first chamber region into a second chamber region due to a movement of a mass element caused by the vibration and due to the liquid transfer from the first chamber region into the second chamber region, for example via a transfer chamber region or via connection regions or ducts, a damping can be ensured. Such a damper is known, for example, from EP 0 164 220 A2.

According to an advantageous further development, the damping unit may comprise a fluidic damping mechanism with a mass-spring system, in particular on the basis of squeeze-film damping and/or on the basis of throttle flow damping.

Preferably, the damping unit includes a mass element which is biased by means of springs and which is mounted on guides so as to be able to oscillate in a main damping effect direction.

Preferably, the mass element is mounted in a fluid-sealed interior space of the damping unit so as to be capable of oscillating, and/or chamber regions of the interior space are at least partially filled with a liquid, in particular with an oil.

Preferably, the damping unit is adapted to replace a mass element of the mass-spring system, to insert or replace spring elements of the mass-spring system, and/or to change a fluid of the fluidic damping mechanism.

According to an advantageous further development, the damping unit may have a housing including a chamber or an interior space, in which a mass element supported on a spring element is mounted in an oscillating manner, wherein in the chamber (interior space) a liquid is provided, which is transferred or transferable from a first chamber region formed between the mass element and a chamber wall into a second chamber region formed between the mass element and the chamber wall upon oscillation.

This advantageous further development is a specific embodiment of such a previously described squeeze-film damping element. In this case, the mass element may be supported on a spring element, preferably suspended or attached in any way to it.

The spring element always brings the mass element into a rest position. When vibrations occur, this mass element is deflected and thus presses a liquid from a first chamber (gap or gap-shaped chamber region) into a second chamber (gap or gap-shaped chamber region) due to the volumes of the first and second gaps or chamber regions changing with this deflection.

If, as a result of the vibration, the mass element is deflected such that the first chamber region between the chamber wall and the mass element is decreased in size and the second chamber region is between the chamber wall and the mass element is increased in size, the liquid contained in the first chamber region is pressed into the second chamber region or drawn into the second chamber region by a simultaneous increase of the volume of the second chamber region.

In embodiments, at least one of the chamber regions may be formed on a lower side of the interior space of the damping housing below the mass element oscillating in the axial direction. Optionally, one or more of the chamber regions may be formed on an upper side of the interior space of the damping housing above the mass element oscillating in the axial direction.

In this case, as described above, the interior space may at least partially be filled with liquid, wherein, at partial filling of the interior, the damping element is oriented on the machining unit in such a way that the axial oscillation direction of the mass element is oriented vertically or at least substantially vertically (i.e., such that the chamber region(s) arranged on the lower side is filled with liquid, e.g., in the case of a planarly formed squeeze-film gap in the region of the lower side of the housing or on the lower side of the interior space).

In this case, it is advantageously sufficient to fill only a small volume of liquid into the interior, such that the lower chamber region(s) or squeeze-film gap is/are filled with liquid, or merely the region of the interior space is filled in such a way that the chamber region(s) arranged on the lower side or a planarly formed squeeze-film gap is/are covered with liquid in the region of the lower side of the housing and/or on the lower side of the interior space.

When the mass element oscillates, the oil or liquid used can be pressed radially outwards or radially inwards from the lower chamber region or the lower gap. On this physical effect (“squeeze-film effect”) the damping acting on the oscillation of the mass element is based, which also dampens oscillations at the machining unit via a rigid fastening of the damping element to the machining unit.

The damping effect may be increased if the interior space is completely filled with liquid, so that both upper and lower chamber regions or gaps, between which the mass element oscillates, are filled with liquid, since the “squeeze film effect” then occurs phase-shifted at the upper and lower surfaces of the interior space at corresponding chamber regions or gaps, wherein liquid is forced radially outwards on one side, when liquid is sucked radially inwards on the opposite side, and vice versa.

In a horizontal or substantially horizontal (or flat oblique) orientation of the axial oscillation direction of the mass element of the damping unit (for example, for damping vibrations with a horizontal main component), the interior space is preferably completely filled with liquid, in particular oil.

According to an advantageous further development, the chamber (interior space) may have a cylindrical shape in the circumferential direction thereof and may be bounded on the upper and lower sides by planar walls; the mass element may have a cylindrical shape in the circumferential direction thereof and may also be bounded on the upper and lower sides by planar walls, wherein a transfer chamber region is arranged between the opposing circumferential walls, and an upper side or lower side chamber region (first, second chamber, or squeeze-film gap) is arranged between the respective upper and lower side planar wall, respectively, the chamber regions each having a variable receiving volume due to the oscillation of the mass element.

Such a configuration substantially provides a cylindrical squeeze-film damper which is cylindrical in the top view thereof, with an upper side variable chamber and a lower side variable chamber and a transfer chamber with a cylindrical shape arranged therebetween, which is formed between the cylindrical outer wall of the mass element and the cylindrical inner wall of the chamber.

By virtue of this cylindrical configuration, which is, in particular, round in the cross-sectional direction, on the one hand a simple manufacturing process may be selected, and on the other hand the mass distribution in the damping unit is also compensated for.

In this case, the damping unit substantially has a cylindrical housing, for example in the form of a drum, with upper and lower sides and cylindrical side walls extending transversely thereto in the circumferential direction.

A mass element is provided in this housing. This mass element may be made of a metal, in particular a high-density metal.

The selected liquid and also the selected mass of the mass element may be matched to the expected vibration frequencies in such a machine tool.

The mass element preferably has a mass of between 50 and 120 kg, advantageously between 75 and 150 kg, in particular 100 (+/−5 kg).

According to an advantageous further development, the mass element may be supported at the upper side and at the lower side by at least one spring element and preferably with a plurality of spring elements.

Accordingly, it is preferred that not only one spring element acts on the mass element from one side, but also the mass element is supported on opposite sides, namely on the upper or lower side, by at least one spring element. The mass element is thus held between at least two spring elements. As such spring elements, simple spiral springs with predetermined spring constants tuned to the expected vibration frequencies may be used. These spring elements are therefore supported between the upper side of the chamber (interior space) and the upper side of the mass element and the lower side of the mass element or lower side of the chamber (interior space). In this case, the side opposite to a lower side is referred to as the upper side. The upper and lower sides are the sides which define the cylindrical side wall in the longitudinal direction. Preferably, the lower side of the chamber (interior space) or of the housing of the damping unit thus forms a support surface to which the damping unit may be attached.

As a result of the aforementioned support of the mass element between the at least two spring elements, a secure mounting may be achieved.

According to an advantageous further development, a plurality of mutually opposite spring elements may be provided along the circumferential wall, to support the mass element on the upper side and on the lower side.

Accordingly, a symmetrical arrangement of spring elements is preferred, preferably at equal distances along the circumferential direction of the mass element. In this way, the mass element may be mounted particularly securely, in particular secured against tilting.

According to an advantageous further development, the spring element may be received in a receiving bore on an upper side or lower side wall of the mass element and may be fastened to the respective opposite wall of the chamber (interior space).

In this case, for example, the end of the spring element (e.g., a spiral spring), which is received in the receiving bore on the upper or lower wall of the mass element, does not have to be connected fixedly to the mass element; instead it may simply be inserted into this bore.

At the respective other end of the spring element, the spring element is preferably fixedly connected to or protrudes into the inner wall of the chamber (interior space) for safe attachment in the chamber (interior space) and is held there in the chamber wall.

According to a preferred further development, longitudinal guide devices (guides) extending between the upper side of the chamber (interior space) and the lower side of the chamber may be provided, so that the mass element is mounted such that it oscillates only in the longitudinal direction, in particular in the direction of the guides.

To make the transfer chamber region homogeneous in the circumferential direction, corresponding longitudinal guide devices are provided, on which the mass element is guided between an upper and a lower side of the chamber (interior space).

Accordingly, the mass element is arranged in the chamber (interior space) such that it is substantially, i.e., with the exception of production tolerances, displaceable only in the longitudinal direction, thus ensuring uniaxial damping.

According to an advantageous further development, the longitudinal guide devices may be formed by rods which project through openings extending between the upper side and the lower side wall of the mass element.

Accordingly, these rods are provided between the upper side limiting wall of the chamber and the lower side limiting wall of the chamber and project through the mass element, from the upper side thereof to the lower side thereof. This ensures a particularly safe guidance.

According to a preferred further development, the openings, through which the rods project, may be provided at uniform distances along the circumference of the mass element. Similar to the springs described above, which are preferably provided along the circumference of the mass element, a balanced mass distribution and a safe guidance may also be ensured by this symmetrical design with respect to the openings.

According to an advantageous further development, a spring element may be provided adjacent to each opening. Due to this immediate vicinity between guide and spring element, a particularly safe uniaxial support of the mass element is ensured.

In particular, the combination is preferred in which both the spring elements and the openings are provided along the circumference, wherein the springs or the bores, into which the springs project, are each provided adjacent to such an opening, on a radially inner or outer side, but in particular on a radially inner side with respect to the opening.

According to an advantageous further development, the housing may be temperature-controlled. Since the viscosity of the liquid in the chamber depends on the temperature, it can be very advantageous to control the temperature of the housing and thus also control the damping property via the temperature.

When the temperature of the liquid is elevated, the viscosity of the liquid may be reduced, and accordingly a damping in a different viscosity range may be provided than at low temperatures of the liquid.

The temperature control can, for example, be coupled to a control device which measures the occurring oscillation frequencies and adapts the corresponding damping characteristics to the measured oscillation frequencies by means of the temperature control of the housing. Such a configuration is provided, for example, by appropriate regulation of the control device.

Preferably, a temperature of the housing is adjustable. Particularly preferably, a temperature controller for adjusting the temperature of the housing includes a vibration sensor whose vibration sensor signal is supplied to the temperature controller for controlling the temperature of the housing.

In this case, the temperature may also be varied in a controlled manner in order to purposefully control the desired damping behaviour by adjusting to the respective required viscosity of the liquid.

When a vibration sensor is used, in a particularly advantageous embodiment, it is also possible to set up a control loop which controls the adjusted temperature of the liquid in the squeeze-film damping element based on a sensor signal of the vibration sensor in order to indirectly control the viscosity of the liquid and consequently indirectly control the oscillation behaviour, in order to damp the occurring oscillations in an optimized manner.

According to an advantageous further development, the housing may have a bottom surface which is mounted on a damping device stand, which is mounted on an outer wall of the carrier head base.

The bottom surface of the housing is usually the lower side of the housing. That is, the mass element oscillates in the longitudinal direction, i.e., the vertical direction with respect to the bottom surface. The damping unit is mounted above this bottom surface. In particular, the translational movement of the mass element may be perpendicular to the bottom surface.

According to a preferred further development of the invention, the damping device stand may include base surface for the housing and a fastening surface for fastening a carrier head base, the base surface being oriented perpendicularly to the movement direction of the carrier head base and the fastening surface being oriented substantially in parallel to the pivot axis of the spindle carrier head.

This ensures that the damping device stands horizontally on an oblique housing surface of the carrier head base. This oblique housing surface is preferably oriented in parallel to the pivot axis, so that the damping unit and the spindle carrier head do not collide with each other during pivoting.

According to an independent aspect, the invention also proposes a machine tool having a machining unit according to at least one of the preceding aspects.

According to an independent aspect, the invention also proposes a machine tool comprising a carriage which is displaceable in a first direction on first axis guides and comprises a workpiece holder, a second carriage which is displaceable on second axis guides in a second direction and which includes axis guides extending in a third direction, and a machining unit according to one of the preceding aspects.

Herein, the machining unit or the longitudinally displaceable carriage of the machining unit is mounted on the axis guides of the second carriage, which extend in the Y-direction.

It should also be emphasized that the above aspects of the damping unit may also be provided independently of a machine tool or independently of a machining unit of a machine tool.

For example, a damping unit is proposed independently, which comprises a fluidic damping mechanism with a mass-spring system, in particular on the basis of a squeeze-film damping and/or on the basis of a throttle flow damping. This independent aspect may be combined with all the features of the preceding aspects and the following exemplary embodiments.

In particular, the proposed damping system is not limited to machine kinematics of machine tools, but may be used universally in all systems in which vibrations are to be dampened (for example, in machines, machine components, motor blocks, structures, buildings, transmissions, vehicle bodies, etc.).

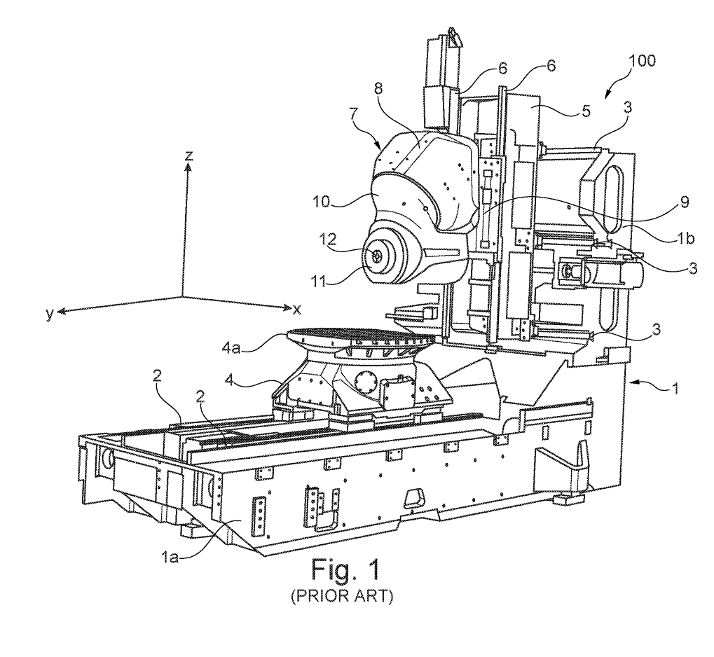

FIG. 1 shows an example of a machine tool 100 known from the prior art having five axes, including three linearly displaceable axes and two rotational axes.

The machine tool 100 may be controllable by means of a numerical controller (not shown), in particular for controlling the displacing movements of the three linear axes and of the two rotational axes for controlling a relative movement between the workpiece to be machined and the tool which machines the workpiece and is held on a spindle of the machine tool 100.

Herein, by way of example, a pair of first axis guides 2 extending horizontally in the Y direction and, extending perpendicularly thereto on a side part 1b (machine stand) of the frame 1 of the machine tool 100, second axis guides 2 extending horizontally in the X direction are arranged on a lower part 1a (machine bed) of a frame 1 (machine frame) of the machine tool 100, which is, for example, L-shaped in side view.

A rotary table 4a, on which a workpiece holder may be provided, is arranged on a first (Y axis) carriage 4 of a Y axis (first linear axis), which is longitudinally displaceable or displaceable on the first axial guides 2 in the Y-direction.

By way of example, a workpiece to be machined may be held or clamped on the rotary table 4a of the rotationally drivable rotational axis, which workpiece may be rotated about a vertical axis of rotation by rotating the rotary table 4a, preferably by at least 360 degrees or more, and may be linearly displaced in the Y-direction by displacing the carriage 4 by means of the Y axis.

A second (X-axis) carriage 5 of an X axis (second linear axis), which is transversely slidable or displaceable in the X direction and which has, for example, a rod-shaped configuration in the height direction, is provided on the second axis guides 3 in order to hold axis guides 6 of a vertical Z axis (third linear axis) along the entire height of the axis guides 6. On the side of the second carriage 5 facing away from the second axis guides 3, the third axis guides 6 extending in the vertical Z direction are thus provided, by way of example.

Furthermore, in the height direction (Z direction) of the machine tool 100 shown in FIG. 1, a machining unit 7 (milling head, spindle head, or spindle stock) is held on or attached to a third (Z axis) carriage 9 of the vertical Z-axis, which is longitudinally slidable or displaceable in the Z direction. The machining unit 7 includes, for example, a carrier head base 8. The rear part of the carrier head base 8 is arranged on the third carriage 9 and is thus mounted vertically displaceable on the third axis guides 6 in the height direction of the machine tool.

In particular, the machining unit 7 may thus, for example, be displaced linearly by means of the X axis by displacing the carriage 5 horizontally in the X direction and transversely to the Y direction, and may be displaced vertically linearly by means of the Z axis by displacing the carriage 9.

On a side of the carrier head base 8 opposite the third carriage 9, for example, a spindle carrier head 10 (e.g., pivot head) is held such that it is arranged pivotably thereon, the spindle carrier head 10 carrying a work spindle 11, on which a tool holder 12 is provided, on which a corresponding tool, for example a cutting tool, a drilling tool or a milling tool for machining a workpiece clamped on the rotary table 4a may be received.

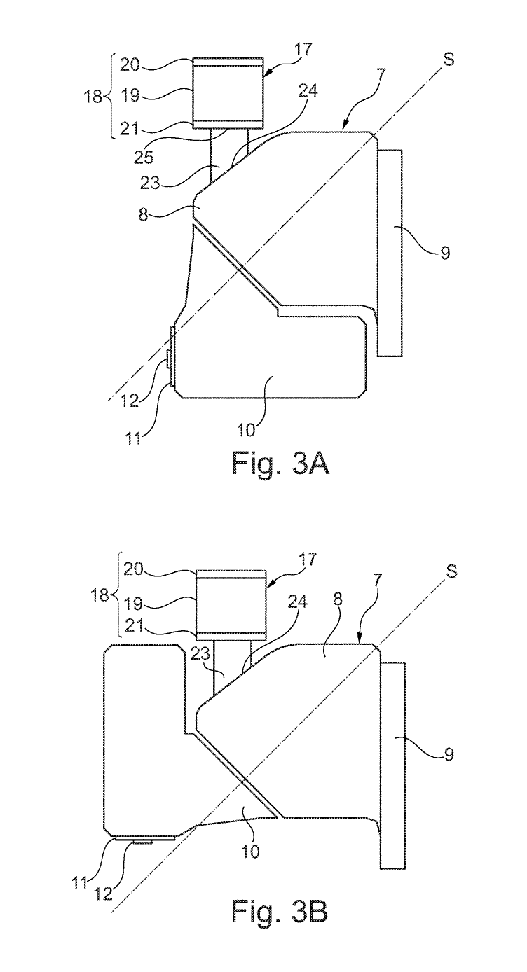

The spindle carrier head 10 is, for example, mounted pivotably about an oblique pivot axis S obliquely with respect to the Z axis or obliquely with respect to the third axis guides 6 or the displacement direction of the third carriage 9 (see also FIGS. 3A and 3B), so that that it can be pivoted between a first position shown in FIG. 1 with a horizontally oriented spindle axis of the spindle 11 and a second position with a vertically oriented spindle axis of the spindle 11.

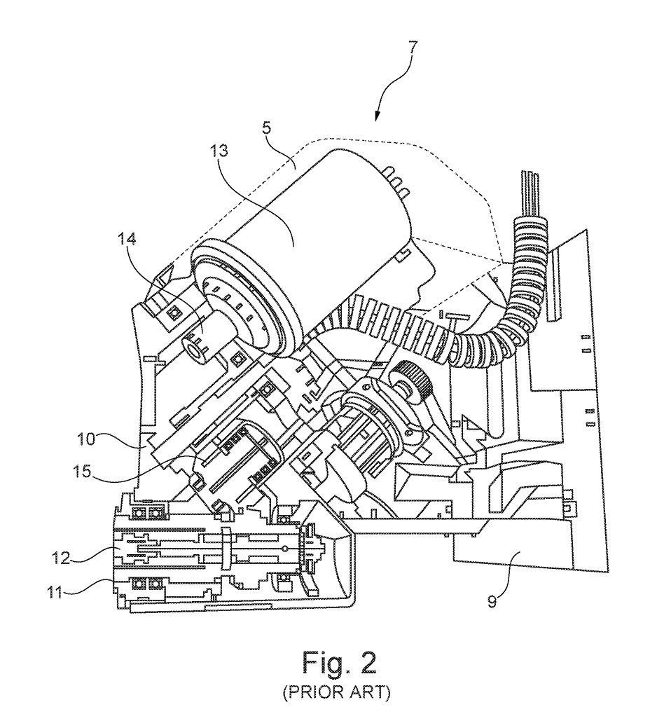

The spindle 11 may be driven via a gear box provided in the spindle support head 10 (see, for example, FIG. 2). An exemplary machining unit 7 of a machine tool known from the prior art is shown in an exemplary schematic diagram in FIG. 2.

Within the carrier head base 8, for example, a motor 13 is arranged which rotationally drives a shaft 14. A rotary movement of the shaft 14 is transmitted via a gear ensemble, which forms a gear box 15, to the spindle 11, which is provided with the tool holder 12 at its front end (see FIG. 1), in order to rotationally drive a tool held on the tool holder 12.

With regard to an exemplary structure of the gear box 15 and the pivoting mechanism of the pivot axis between the carrier head base 8 and the spindle carrier head 10, reference is made to EP 1 415 758 A1.

FIGS. 3A and 3B schematically show the machining unit 7 from FIGS. 1 and 2, the carrier head base 8 being provided according to the invention with a damping unit 17, which is arranged, only as an example, on the upper side of the carrier head base 8.

However, the invention is not restricted to exemplary embodiments in which a damping unit 17 is arranged or mounted on the upper side of the carrier head base 8, but one or more damping units may also be arranged and/or mounted at other points of the carrier head base 8 and/or the spindle carrier head 10.

Furthermore, the present invention is not limited to machining units with a pivot axis or with two carrier portions pivotable with respect to one another, but may be extended to various spindle-bearing machining units or spindle or milling heads with tool-carrying work spindles for machine tools.

In the case illustrated in FIGS. 3A and 3B, the damping element 17 is provided, for example, with a separate element, which is arranged on the outer side of the housing of the machining unit 7.

However, the present invention is not limited to such damping elements 17 arranged on the outside, but one or more damping elements 17 may be integrated in the machining unit 7 and may be installed, in particular, inside the machining unit 7 or the carrier head base 8 and/or the spindle carrier head 10.

Furthermore, damping elements may additionally or alternatively also be arranged at other points of the machine tool 100, e.g., on the machine frame, on the machine bed, on the axis carriages and/or on the rotary table or on or adjacent to a workpiece clamping device.

The damping element 17 of FIGS. 3A and 3B includes, for example, a housing 18 having an exemplary cylindrical circumferential wall 19, an exemplary planar upper side wall 20 (lid portion) and an exemplary planar lower side wall 21 (bottom portion). In the interior of the housing 18, these walls 19, 20, 21 form an exemplary cylindrical interior space 22, in which oscillation damping mechanisms or damping elements may be provided.

The lower side wall 21 of the housing 18 forms, for example, the base surface of the damping unit 17 and is mounted, for example, on a schematically illustrated damping device stand 23. This damping device stand 23 is, for example, a separate element and may, for example, be made of metal or plastic.

The damping device stand 23 includes, for example, a fastening surface 24, by means of which the damping device stand 23 is fastened to a housing wall of the support head base 8. In addition, the damping device stand 23 includes, for example, a base surface 25, via which the lower side wall 21 of the housing 18 is fastened to the damping device stand 23.

The base surface 25 and the fastening surface 24 have, for example, angles of approximately 45 degrees to one another, since, in particular, a corresponding oblique surface on the upper side of the housing of the carrier head base 8 is likewise arranged obliquely.

The fastening surface 24 and also the oblique surface on the upper side of the housing of the carrier head base 8 are essentially parallel to the pivot axis S, which extends, for example, obliquely with an angle of approximately 45 degrees to the Z axis (see FIG. 1).

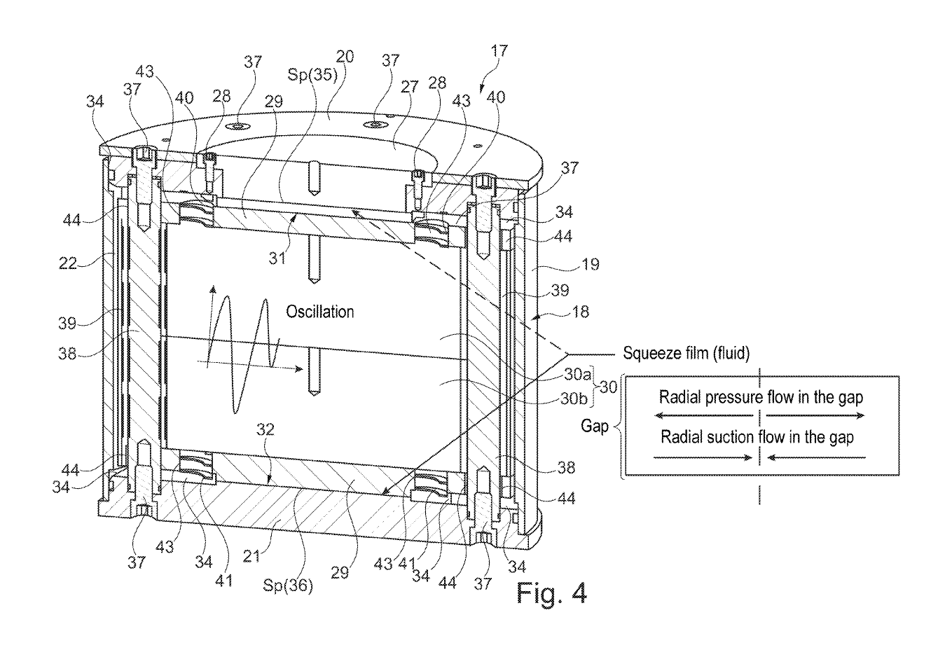

The more acute the angle between the Z axis and the pivot axis S is, the greater the angle between the fastening surface 24 and the base surface 25 can be. However, the two angles (the angle between the fastening surface 24 and the base surface 25 and the angle of the pivot axis S with respect to the Z axis) yield in total, for example, 90 degrees, so that the lower side wall 21 of the damping unit 17 is planar and the damping unit 17 is vertical (wherein, in embodiments, a mass element 30 provided in the interior space 22 may be held such that it is translationally movable, for example, in the vertical Z direction; see FIG. 4).

A damping device stand 23 is not absolutely necessary. Alternatively, the housing 18 of the damping unit may also be fastened directly to the housing of the machining unit or the carrier head base 8 without the intermediary element of a damping device stand 23 of this kind, or may be arranged in the interior thereof.

An exemplary damping unit 17 according to a non-limiting embodiment is shown in the sectional view in FIG. 4 by way of example. By way of example, a “damping unit” based on a “squeeze film” is proposed in the present exemplary embodiment.

In the present exemplary embodiment, the damping unit 17 is thus formed, as an example, as a squeeze-film damping element (which is also referred to as a so-called squeeze-film damper). Alternatively, however, any known damping element may be used as a damping unit. Such a damping unit may also include a viscoelastic damping element, an electrodynamic damping element and/or a piezoelectric damping element, or a combination thereof.

In the present case, the housing 18 of the damping unit 17 substantially comprises the exemplary cylindrical circumferential wall 19, as well as a lid or lid portion 20, which delimits the interior space 22 from above in the longitudinal direction and which forms the upper side wall, and a bottom or bottom portion 21, which delimits the interior space 22 from below in the longitudinal direction and which forms the lower side wall.

In FIG. 4, the upper lid 20 of the housing 18 is provided, merely by way of example, with a central plate element 27 which closes the interior space 22 sealingly and, in particular, liquid-tightly, by means of the screws 28 or other fastening means. Here, the wall thickness of the plate element 27 may be selected such that a gap of the squeeze film damping formed under the plate element 27 may be adjusted to a desired gap width based on the desired damping effect of the squeeze film damping. By replacing the plate element 27 with a plate element of a different wall thickness, a different gap width can be obtained. As soon as the plate element 27 is removed, liquid can be replenished or replaced, for example, in the interior space 22.

In the present case, a mass element 30 formed by two cylindrical disks 30a and 30b is arranged, by way of example. The outer circumferential surface of the mass element 30 has, for example, a cylindrical shape and corresponds, for example, to the shape of the cylindrical inner circumferential surface of the housing 18, which delimits the interior space 22 (outer circumferential wall of the interior space).

The mass element 30 is held on the upper side and on the lower side by an upper holding element 29 and a lower holding element 29, respectively, or between the upper and lower holding elements 29. The holding elements 29 are each disk-shaped, for example.

Respective rod-shaped guide elements 38, which are fastened to the lid portion 20 and bottom portion 21, for example, by means of screws 37, respectively, extend vertically between the lid portion 20 and the bottom portion 21. On the lid 20 and the bottom 21 of the housing 18, rods 38, which serve, by way of example, as guide elements, are provided, the rods being formed as separate elements and being connected by means of the screws 37 or other fastening means to the corresponding lid or bottom of the housing.

These rods or guide elements 38 are provided at equal intervals along the outer circumferential surface of the housing 18 and project through openings 39, which are respectively provided in the mass element 30 and are provided at corresponding locations of the mass element 30. Furthermore, the guide elements 38 extend through openings 44 (e.g., bores) formed in the holding elements 29.

In the interior space 22 of the housing 18 of the damping element 7, the mass element 30 with the holding elements 29 is thus mounted such that it can freely slide along the guide elements 38.

The mass element 30 is held between spring elements 40, 41, wherein lower spring elements 40 each support the mass element 30 and upper spring elements 41 each press onto the mass element 30. The spring elements 40 and 41 are each held or supported in corresponding openings 43 (e.g., bores). Thus, for the mass element 30, a translatory spring suspension displaceable in the vertical direction is provided.

The corresponding spring elements 40, 41 are, for example, formed as spiral springs, one end of the respective spiral spring being fixed to the lid or the bottom and the other end of the spiral spring being supported in an opening 43 or a base area of the opening 43, for example, without being fixed to it.

The respective upper side and lower side spring elements 40, 41 are each arranged opposite one another in the vertical direction and are arranged as an extension of one another, wherein a pair of upper and lower spring elements 40, 41 is arranged in parallel to the openings 39 and the guide elements 38, respectively. Thus, in the circumferential direction along the housing 18, there is always provided, for example, a pair of a rod 38 and spring elements 40, 41.

Between the upper side wall 31 of the upper holding element 29 and the inner surface of the plate element 27, a gap Sp is formed, which forms an upper squeeze-film chamber portion 35 for receiving liquid, and between the lower side wall 32 of the lower holding element 29 and the inner surface of the bottom portion 21 another gap Sp is formed, which forms a lower squeeze-film chamber region 36 for receiving liquid.

The upper and lower squeeze-film chamber regions 35 and 36 are each formed with a transfer chamber region 34 formed in remaining cavities in the interior space 22 for receiving liquid. The transfer chamber region 34 is formed, for example, between the outer circumferential surface of the mass element 30 and the inner circumferential surface of the housing 18, which surrounds the mass element 30, for example, completely in the circumferential direction of the housing element 30 and substantially has a constant cross-section in the present example.

The mass element 30 oscillates slidingly up and down along the guide elements 38 in the liquid when vibration occurs during the machining of a workpiece in the interior space 22.

The volume of the gap regions of the gap Sp or of the chamber regions 35 and 36 is varied, as a result of which the lower gap Sp is increased, in particular, when the mass element 30 moves upward, and the volume of the chamber region 36 increases, and the upper gap Sp decreases, and the volume of the chamber region 35 decreases, or, as a result of which the upper gap Sp is increased, in particular, when the mass element 30 moves downwards, and the volume of the chamber region 35 increases, and the lower gap Sp decreases, and the volume of the chamber region decreases.

When, for example, in FIG. 4 the mass element 30 moves upwards, when at least the lower part of the interior space 22 is filled with liquid (i.e., if the interior space 22 is only partly filled with liquid), the chamber volume of the lower gap or of the chamber region 36 is increased, and the liquid located in the transfer chamber region 34 is transferred into the gap or sucked from the transfer chamber region 34 into the gap by a radial suction flow occurring in the gap (cf. the right-hand detailed view on the right bottom side in FIG. 4).

When the mass element 30 moves downwards again, the chamber volume of the lower gap or the chamber region 36 is decreased and the liquid located therein is transferred into the transfer chamber region 34 or pushed out into the transfer chamber 34 by a radial pressure flow occurring in the gap (cf. the right-hand detailed view on the right bottom side in FIG. 4).

When the interior space 22 and the chamber regions 34, 35 and 36 are completely filled with liquid and the mass element 30 moves downwards, the chamber volume of the upper gap or the chamber region 35 is increased, and the liquid in the transfer chamber region 34 is transferred into the gap or sucked into the gap by a radial suction flow occurring in the gap (cf. the right-hand detailed view on the right bottom side in FIG. 4). When the mass element 30 moves upwards again, the chamber volume of the upper gap or the chamber region 35 is decreased, and the liquid located therein is transferred into the transfer chamber region 34 or pressed into the transfer chamber 34 by a radial pressure flow occurring in the gap (cf. the right-hand detailed view on the right bottom side in FIG. 4).

Thus, due to the pressure or suction flows occurring in the gap regions, a damping effect on an oscillation of the mass element 30, which also acts as an oscillation damping on the entire machining unit, occurs both when the interior region 22 of the damping element 7 is filled partially and completely with liquid, in particular, when the damping element is rigidly attached to the machining unit.

Thus, at least one of the chamber regions may be formed on a lower side of the interior space of the damping housing below the mass element oscillating in the axial direction. Optionally, one or more of the chamber regions may be formed on an upper side of the interior space of the damping housing above the mass element oscillating in the axial direction.

In this case, as described above, the interior space may at least partially be filled with liquid, wherein, at partial filling of the interior space, the damping element is oriented in such a way on the machining unit that the axial oscillation direction of the mass element is oriented vertically or at least substantially vertically (i.e., in particular, such that the chamber region(s) arranged on the lower side is/are filled with liquid, e.g., in the case of a planarly formed squeeze-film gap in the region of the lower side of the housing or on the lower side of the interior space).

In this case, it is advantageously sufficient to fill only a small volume of liquid into the interior space such that the lower chamber region(s) or squeeze-film gap is filled with liquid or just the region of the interior space is filled in such a way that the chamber region(s) arranged on the lower side or a planarly formed squeeze-film gap is/are covered with liquid in the region of the lower side of the housing and/or at the lower side of the interior space.

When the mass element is oscillated, the oil or liquid used may be pushed radially outwards or radially inward from the lower chamber region or the lower gap. On this physical effect (“squeeze-film effect”) the damping acting on the oscillation of the mass element is based, which also dampens oscillations at the machining unit via a rigid fastening of the damping element to the machining unit of the machine tool.

The damping effect may be increased when the interior space is completely filled with liquid, so that both upper and lower chamber regions or gaps, between which the mass element oscillates, are filled with liquid, since the “squeeze-film effect” then occurs phase-shifted at the upper and lower sides of the interior space corresponding chamber regions or gaps, wherein liquid is pushed radially outwards on one side when liquid is sucked radially inwardly on the opposite side, and vice versa.

With a horizontal or substantially horizontal (or flatly oblique) orientation of the axial oscillation direction of the mass element of the damping unit (for example, for dampening oscillations with a horizontal main component), the interior space is preferably completely filled with liquid, in particular oil.

The mass element preferably has a mass between 50 and 120 kg, advantageously between 75 and 150 kg, in particular 100 (+/−5) kg. The mean gap width is, in particular, preferably less than 10 mm, or preferably less than 5 mm, and, in particular, substantially 1 mm.

In experiments on machine tools having a machining unit equipped with a squeeze-film damping unit of the exemplary design described above, it could be shown that, in the case of machining a workpiece after attaching a squeeze-film damping unit to the machining unit, while a material removal rate was increased by up to 500%, the same surface quality could be achieved in the machined workpiece surface as in machining on a machine tool without a damping unit.

The selected liquid, in particular preferably an oil, and also the selected mass of the mass element may be matched to the expected vibration frequencies in such a machine tool.

In the present example, the housing 18 is, for example, temperature-controlled. Since the viscosity of the liquid in the chamber depends on the temperature, it is very advantageous to temperature-control the housing 18 and thus to control the damping property also via the temperature. It may thus be ensured that the temperature of the liquid can be kept constant, so that the viscosity and thus the oscillation damping behaviour during the machining of the workpiece does not change over time since the temperature-dependent viscosity of the liquid, in particular of an oil, is kept constant.

When the temperature of the liquid is elevated, the viscosity of the liquid may be reduced and accordingly a damping in a different viscosity range may be provided than at low temperatures of the liquid.

The temperature control can, for example, be coupled to a control device which measures the occurring oscillation frequencies and adapts the corresponding damping characteristics to the measured oscillation frequencies via the temperature control of the housing. Such a configuration is provided, for example, by appropriate regulation of the control device.

In this case, the temperature may also be varied in a controlled manner in order to purposefully control the desired damping behaviour by adjusting to the respective required viscosity of the liquid.

When a vibration sensor is used, in particularly advantageous embodiments, it is also possible to set up a control loop which controls the adjusted temperature of the liquid in the squeeze-film damping element based on a sensor signal of the vibration sensor in order to indirectly control the viscosity of the liquid and, consequently, to indirectly control the oscillation behaviour, in order to damp the occurring oscillations in an optimized manner.

Furthermore, it is possible to change the type (in particular with respect to the spring constant) and/or the number of springs used and to adjust the damping unit to the frequency ranges to be damped. By varying the number of springs of up to 100 springs used, it could be shown in experiments that the attenuated frequency range of the oscillations at a constant oscillating mass of the damper can be adjusted between 3 Hz and 100 Hz merely by varying the number of springs used.

The oscillation damping behaviour may be optimally adjusted by adjusting the type and/or number of springs, the average gap width of the squeeze-film damping arrangement, and by selecting the liquid or its viscosity as well as by adjusting or varying the viscosity by means of temperature control, possibly on the basis of a control loop with a vibration sensor connected to the temperature control.

The present invention is not limited to the implementation of a squeeze-film damping. Rather, different damping elements may also be used, and, in particular other types of fluidic damping mechanisms with mass-spring systems (e.g., fluidic damping mechanisms with mass-spring systems on a squeeze-film basis, fluidic damping mechanisms with mass-spring systems based on throttle flows). Mass-spring systems generally offer the advantage that the biased oscillatable mass allows a particularly compact design with a high power density.

In the case of fluidic damping mechanisms with mass-spring systems, the damping behaviour with the modular principle may simply be adjusted variably by the mass of the mass element being suitably selectable by the material selection or the density of the material used (for this purpose, a plurality of mass elements of the same size and shape at different masses due to different densities may be provided and exchanged in the damping element), by the type and, in particular, the number of springs used being variable for adapting the frequency range of the oscillations to be damped, by the gap height of the gaps or of the liquid chambers being adjustable (e.g., by adjustment or exchange of the upper plate element 27 and/or the holding elements 29), by selecting the liquid used depending on the viscosity, and/or by the viscosity of the liquid being adjustable or being fine-tuneable by controlling the temperature of the damping unit or the chamber walls.

In addition, a plurality of damping elements may be used, each with different compositions with respect to the mass of the mass element used, the gap heights used, the springs used (with regard to type and/or number), the liquid used and/or the temperature of the temperature-controlled damping element to be set, in order to be able to damp multiple eigenfrequencies of the machine system of the machine tool or of the machining unit to be damped at the same time.

However, the use of a plurality of damping elements may not only be used to dampen a plurality of frequency ranges or different frequencies, but also makes it possible to dampen different oscillation directions when the damping elements are arranged on the machining unit at different oscillation directions of the spring-mass system. By means of the guides (for example, guide elements 38) of the spring-mass system, horizontally oriented oscillation damping is also possible, or horizontal oscillations can be damped.

In addition, when a plurality of damping elements are used, the mass of the individual damping elements may be reduced, so that a plurality of damping elements may each be made more compact, and the installation volume of the individual damping elements may be reduced so that, advantageously, a simple and space-saving attachment or integration of the dampers to/into the machine tool or to/into the machining unit is made possible.

This also allows to provide space-saving damping elements even at a smaller mass of the mass element (for example, preferably between 20 kg and 30 kg, or between 10 kg and 50 kg), which may be used for smaller machine tools (so-called small machines) for oscillation damping, or which may also be used in large machine tools (so-called large machines), if a plurality of damping elements is used.

In summary, the present invention allows to provide improved chip-removing machining of a workpiece on a machine tool, with which both the highest possible machining precision at a high achievable surface quality as well as the highest possible productivity at a high material removal rate can be achieved.

In particular, it is advantageously possible to dampen the oscillations occurring during the machining of the workpiece, so that, at a higher material removal rate, due to a oscillation damping unit on the machining unit of the machine tool carrying the working spindle and the associated oscillation damping during machining of the workpiece at higher feed rates and/or deeper plunging of the tool into the workpiece in order to increase the productivity and operating performance of the machine tool, a significantly increased machining precision and an improved surface quality can be achieved.

While illustrative embodiments have been illustrated and described, it will be appreciated that various changes can be made therein without departing from the spirit and scope of the invention.

The embodiments of the invention in which an exclusive property or privilege is claimed are defined as follows:

1. A machining unit for a machine tool, comprising
a carrier head base, and
a spindle carrier head holding a tool-carrying work spindle,
characterized in that said machining unit is provided with a damping unit for damping oscillations occurring during the machining of a workpiece on said machine tool.

2. The machining unit according to claim 1, wherein said carrier head base is provided with said damping unit, and/or said spindle carrier head is provided with said damping unit.

3. The machining unit according to claim 1, wherein said damping unit is arranged on an outer side of a housing of said carrier head base and/or on an outer side of said housing of said spindle carrier head.

4. The machining unit according to claim 1, wherein said damping unit is provided as a separate element, which can be mounted or demounted.

5. The machining unit according to claim 1, wherein said damping unit provides a uniaxial damping and is, in particular, configured to dampen oscillations in a main damping effect direction.

6. The machining unit according to claim 1, wherein a plurality of damping units with respective uniaxial damping are provided, the main damping effect directions thereof being oriented in different directions of said machining unit.

7. The machining unit according to claim 1, wherein said damping unit includes at least one of the following types of damping: a viscoelastic damping element, a piezoelectric damping element, an electrodynamic damping element and a squeeze film damping element.

8. The machining unit according to claim 1, wherein said damping unit comprises a fluidic damping mechanism with a mass-spring system, in particular on the basis of squeeze-film damping and/or on the basis of throttle flow damping.

9. The machining unit according to claim 1, wherein said damping unit includes a mass element, which is biased by means of springs and which is mounted on guides so as to be capable of oscillating in a main damping effect direction.

10. The machining unit according to claim 1, wherein said mass element is mounted in a fluid-sealed interior space of said damping unit for oscillating movement, and chamber regions of said interior space are at least partially filled with a liquid, in particular with an oil.

11. The machining unit according to claim 1, wherein said damping unit is configured to replace a mass element of the mass-spring system, to insert, remove or replace spring elements of the mass-spring system, and/or to change a fluid of the fluidic damping mechanism.

12. The machining unit according to claim 1, wherein said damping unit comprises a housing including an interior space, in which a mass element supported on a spring element is mounted in an oscillating manner, wherein in said chamber a liquid is provided, which, when said mass element is oscillating, is transferable from a first chamber region formed between said mass element and a chamber wall into a second chamber region formed between said mass element and a chamber wall.

13. The machining unit according to claim 12, wherein said interior space has a cylindrical shape in the circumferential direction thereof and is bounded on the upper and lower sides by planar walls;
said mass element having a cylindrical shape in the circumferential direction thereof and being bounded on the upper and lower sides by planar walls;
wherein a transfer chamber region is arranged between the opposing circumferential walls, and upper side or lower side chamber regions are arranged between the respective upper and lower side planar walls, said chamber regions having a variable receiving volume due to the oscillation of said mass element.

14. The machining unit according to claim 12, wherein said mass element is supported at the upper side and at the lower side by at least one spring element.

15. The machining unit according to claim 12, wherein a plurality of mutually opposite spring elements are provided along the circumferential wall, which support said mass element on the upper side and on the lower side.

16. The machining unit according to claim 12, wherein said at least one spring element is received in a receiving bore on an upper side or lower side wall of said mass element and is fastened to the respective opposite wall of said interior space.

17. The machining unit according to claim 12, wherein guides extending between the upper side of the interior space and the lower side of said interior space are provided such that said mass element is mounted for oscillating movement in a guided manner in the direction of said guides.

18. The machining unit according to claim 12, wherein said guides are formed by rods which protrude through openings extending between the upper side and the lower side surfaces of said mass element.

19. The machining unit according to claim 18, wherein said openings, through which said rods protrude, are provided at equal intervals along the circumference of said mass element.

20. The machining unit according to claim 18, wherein a spring element is provided adjacent to each opening.

21. The machining unit according to claim 20, wherein said housing is temperature-controlled.

22. The machining unit according to claim 21, wherein the temperature of said housing is adjustable.

23. The machining unit according to claim 22, wherein a temperature controller for adjusting the temperature of said housing includes a vibration sensor, a vibration sensor signal of which is supplied to said temperature controller for controlling the temperature of said housing.

24. The machining unit according to claim 1, wherein said housing includes a bottom surface which is mounted on a damping device stand, which is mounted on an outer wall of said machining unit.

25. The machining unit according to claim 24, wherein said damping device stand includes a base surface for said housing and a fastening surface for fastening to said carrier head base, said base surface being oriented perpendicularly to the movement direction of said carrier head base, and said fastening surface being oriented substantially in parallel to a pivot axis of said spindle carrier head.

26. A machine tool comprising a machining unit according to claim 1.
